(19) United States
(12) Patent Application Publication
(10) Pub. No.: US 2003/0000642 A1
(43) Pub. Date: Jan. 2, 2003

(54) Glue strip for book binding

(76) Inventors: Yuval Dim, Tel Aviv (IL); Gil Rosenfeld, Beit Itzhak (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 10/184,917

(22) Filed: Jul. 1, 2002

Related U.S. Application Data
(60) Provisional application No. 60/301,814, filed on Jul. 2, 2001.

(51) Int. Cl. C09J 7/00; B32B 31/20

(52) U.S. Cl. 156/308.2; 156/908; 156/277; 428/346

(57) ABSTRACT

According to some embodiments of the invention, a method for bookbinding is provided. The method comprises placing a strip of hot-melt adhesive tape between a spine of a book block and a central region of a cover. The hot-melt adhesive tape comprises a first layer having a first hot-melt adhesive substance having a first viscosity and a second layer having a second hot-melt adhesive substance having a second viscosity that is higher than the first viscosity when heated. The strip of the hot-melt adhesive is placed such that the first layer of the tape is positioned next to the spine and the second layer is positioned next to the central region of the cover.

### CROSS REFERENCE TO RELATED APPLICATIONS

The present application claims priority from U.S. provisional application Serial No. 60/301,814, filed July 2, 2001.

### BACKGROUND OF THE INVENTION

Printed pages may be bound into a book using various methods, for example, using a hot-melt adhesive. In this method, a hot-melt adhesive may be applied to an inner surface of a central portion of a cover or to a spine of a book block. The cover may then be positioned such that the inner surface of its central portion abuts the spine. Heat and pressure may be applied to the contact area to cause the cover and the spine to adhere.

When heat is applied to the hot-melt adhesive, the substance changes from a high to a low viscous state. When the adhesive is in the low viscous state, pressure may be applied to the spine area causing the adhesive to spread out over the desired location, adhering to the pages and cover. Once the adhesive has cooled, the adhesive returns to its original high viscous state.

If the adhesive is not sufficiently heated, the viscosity does not become low enough, and the adhesive may not spread between the pages. On the other hand, if the adhesive is over heated, the viscosity of the adhesive may become too low, and the adhesive may run off into undesired locations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a hot-melt adhesive tape according to some embodiments of the present invention; and

FIG. 2 is a schematic illustration of the adhesive tape of FIG. 1 as utilized to bind a book according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Some embodiments of the present invention are directed to a method for bookbinding. A hot-melt adhesive tape having layers with different viscous properties in the melted state is used. The tape may be positioned between a spine of a book block and an inner surface of a central portion of a book cover such that a layer having a high-viscosity hot-melt adhesive substance may be positioned next to the cover and a layer having a low-viscosity hot-melt adhesive may be positioned next to the spine.

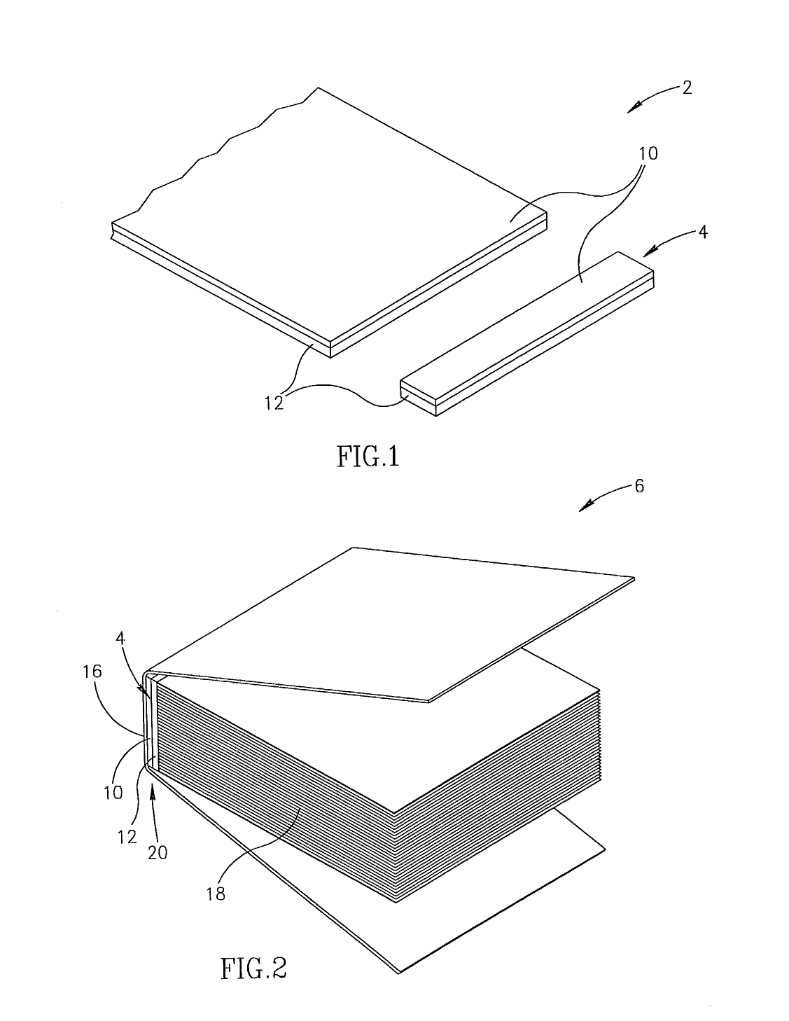

Reference is now made to FIG. 1, which is a schematic illustration of a hot-melt adhesive tape according to some embodiments of the present invention. In the exemplary configuration, shown in FIG. 1, a hot-melt adhesive tape 2 may comprise a first adhesive layer 10 and a second adhesive layer 12. The widths of layers 10 and 12 may vary according to the application's requirements. However, it should be noted that tape 2 may have a different configuration, such as, for example, having at least another adhesive or non-adhesive layer in between layers 10 and 12.

Adhesive layer 10 may comprise a high-viscosity hot-melt adhesive substance. Adhesive layer 12 may comprise a low-viscosity hot-melt adhesive substance. When heated to a high temperature, such as, for example, between 80° C. and 200° C., the viscosity of the adhesive substance of layer 10 may be, for example, 5000 CPS. When heated to a high temperature, such as, for example, between 80° C. and 200° C. the viscosity of the adhesive substance of layer 12 may be, for example, 1900-2250 CPS. At room temperature, the viscosity of the adhesive substances of both layers may be similar. In some alternative embodiments, the viscosity of the adhesive substance of layer 10 may be different from that of layer 12 also at room temperature.

When the high-viscosity hot-melt adhesive substance is heated, it remains highly viscous and therefore practically immobile in comparison to a low-viscosity hot-melt adhesive substance that when heated becomes fluid and tends to flow.

The low-viscosity adhesive substance may be selected according to desired properties, such as, for example, viscosity, penetration properties, wetting properties, binding temperature and speed. Typically, tape 2 may be in a form of a roll (not shown) having a width that is generally equal to the length of the pages of a book block being bound. Tape 2 is cut to a desired size at the time of use. Generally, the size to which tape 2 is cut when binding is substantially equal to the width of the spine of the book block.

This is especially useful in a book machine or other made-to-order printing/binding machine by winch the pages are printed and/or collated at a store or an office location. In such a situation, once the pages are collated and the eventual width of the stack is known, the strip of adhesive tape 2 is then cut to the appropriate width. An example of such a machine is described in WO 01/56794 to the common assignee.

Reference is now made to FIG. 2, which is a schematic illustration of a book having a hot-melt adhesive tape according to some embodiments of the present invention. An exemplary book 6, having a plurality of pages 18 aligned into a book block having a spine 20 and a cover having a central portion 16, is described. A strip 4 of hot-melt adhesive tape 2, described hereinabove with respect to FIG. 1, may be placed between an inner surface of central portion 16 and spine 20 causing them to adhere.

By using different viscosity layers, adhesive strip 4 may enable adhesion to both the cover and the pages such that layer 10, being of higher viscosity when heated, may adhere to central portion 16 of the cover book without leakage. The adhesive substance of layer 12, being of lower viscosity than that of layer 10 when heated may spread into the pages to afford adequate adhesion.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
placing a strip of hot-melt adhesive tape between a spine of a book block and a central region of a cover, said hot-melt adhesive tape comprising a first layer comprising a first hot-melt adhesive substance having a first viscosity when heated and a second layer comprising a second hot-melt adhesive substance having a second viscosity that when heated is higher than said first viscosity,
wherein placing said strip comprises:
positioning said first layer of said tape next to said spine; and
positioning said second layer next to said central region of said cover.

2. The method of claim 1, further comprising:
applying heat to said first adhesive substance and said second adhesive substance.

3. In a printing system for printing books on demand, an automatic bookbinding method comprising:
aligning pages into a book block having a spine;
placing a strip of hot-melt adhesive tape between said spine and a central region of a cover, said hot-melt adhesive tape comprising a first layer comprising a first hot-melt adhesive substance having a first viscosity when heated and a second layer comprising a second hot-melt adhesive substance having a second viscosity that when heated is higher than said first viscosity,
wherein placing said strip comprises:
positioning said first layer of said tape next to said spine; and
positioning said second layer next to said central region of said cover.

4. The method of claim 3, further comprising:
applying heat to said first adhesive substance and said second adhesive substance.

5. A hot-melt adhesive tape comprising:
a first adhesive layer comprising a first hot-melt adhesive substance having a first viscosity when heated; and
a second adhesive layer comprising a second hot-melt adhesive substance having a second viscosity that when heated is higher than said first viscosity.

6. The adhesive tape of claim 5 further comprising a non-adhesive layer positioned between said first and said second adhesive layers.

7. The adhesive tape of claim 5 further comprising at least one additional adhesive layer positioned between said first and said second adhesive layers.
